(19) United States
(12) Patent Application Publication
(10) Pub. No.: US 2026/0040233 A1
(43) Pub. Date: Feb. 5, 2026

(54) APPARATUSES AND USER EQUIPMENT FOR POWER HEADROOM REPORT BASED ON TIME-DOMAIN PREDICTED CHANNEL METRIC

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US); Hamed PEZESHKI, San Diego, CA (US)

(21) Appl. No.: 19/100,093

(22) PCT Filed: Sep. 30, 2022
(86) PCT No.: PCT/CN2022/123561

§ 371 Date: Jan. 30, 2025

(51) Int. Cl. H04W 52/36; H04W 52/14

(52) U.S. Cl. CPC H04W 52/365; H04W 52/146

(57) ABSTRACT

Certain aspects relate to power headroom report (PHR) based on a predicted channel metric. For example, an apparatus may obtain, from a network entity, a reference signal and a configuration indicating a set of one or more parameters. The apparatus may calculate a path loss based on a predicted channel metric of the reference signal. The apparatus may generate a power headroom report (PHR) based on at least one of the set of one or more parameters, a set of one or more conditions, or the calculated path loss, wherein the PHR indicates at least a power headroom (PH) at a future time instance. The apparatus may output the PHR for transmission to the network entity, the output being based on the set of one or more conditions.

### BACKGROUND

### Technical Field

The present disclosure generally relates to communication systems, and more particularly, to power headroom report based on predicted channel metric.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

There exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a user equipment. In some examples, the method includes obtaining, from a network entity, a reference signal and a configuration indicating a set of one or more parameters. In some examples, the method includes calculating a path loss based on a predicted channel metric of the reference signal. In some examples, the method includes generating a power headroom report (PHR) based on at least one of the set of one or more parameters, a set of one or more conditions, or the calculated path loss, wherein the PHR indicates at least a power headroom (PH) at a future time instance. In some examples, the method includes outputting the PHR for transmission to the network entity, the output being based on the set of one or more conditions.

Certain aspects are directed to a method for wireless communication at a network entity. In some examples, the method includes outputting, for transmission to a User Equipment (UE), a reference signal and a configuration indicating a set of one or more parameters. In some examples, the method includes obtaining, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric.

Certain aspects are directed to an apparatus configured for wireless communication, comprising a memory comprising instructions and one or more processors configured to execute the instructions. In some examples, the apparatus is configured to obtain, from a network entity, a reference signal and a configuration indicating a set of one or more parameters. In some examples, the apparatus is configured to calculate a path loss based on a predicted channel metric of the reference signal. In some examples, the apparatus is configured to generate a power headroom report (PHR) based on at least one of the set of one or more parameters, a set of one or more conditions, or the calculated path loss, wherein the PHR indicates at least a power headroom (PH) at a future time instance. In some examples, the apparatus is configured to output the PHR for transmission to the network entity, the output being based on the set of one or more conditions.

Certain aspects are directed to an apparatus configured for wireless communication, comprising a memory comprising instructions and one or more processors configured to execute the instructions. In some examples, the apparatus is configured to output, for transmission to a User Equipment (UE), a reference signal and a configuration indicating a set of one or more parameters. In some examples, the apparatus is configured to obtain, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric.

Certain aspects are directed to a non-transitory computer-readable medium having instructions stored thereon that, when executed by an apparatus, cause the apparatus to perform operations comprising obtaining, from a network entity, a reference signal and a configuration indicating a set of one or more parameters. In some examples, the operations include calculating a path loss based on a predicted channel metric of the reference signal. In some examples, the operations include generating a power headroom report (PHR) based on at least one of the set of one or more parameters, a set of one or more conditions, or the calculated path loss, wherein the PHR indicates at least a power headroom (PH) at a future time instance. In some examples, the operations include outputting the PHR for transmission to the network entity, the output being based on the set of one or more conditions.

Certain aspects are directed to a non-transitory computer-readable medium having instructions stored thereon that, when executed by an apparatus, cause the apparatus to perform operations comprising outputting, for transmission to a User Equipment (UE), a reference signal and a configuration indicating a set of one or more parameters. In some examples, the operations include obtaining, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric.

Certain aspects are directed to an apparatus for wireless communication. In some examples, the apparatus includes means for obtaining, from a network entity, a reference signal and a configuration indicating a set of one or more parameters. In some examples, the apparatus includes means for calculating a path loss based on a predicted channel metric of the reference signal. In some examples, the apparatus includes means for generating a power headroom report (PHR) based on at least one of the set of one or more parameters, a set of one or more conditions, or the calculated path loss, wherein the PHR indicates at least a power headroom (PH) at a future time instance. In some examples, the apparatus includes means for outputting the PHR for transmission to the network entity, the output being based on the set of one or more conditions.

Certain aspects are directed to an apparatus for wireless communication. In some examples, the apparatus includes means for outputting, to a User Equipment (UE), a reference signal and a configuration indicating a set of one or more parameters. In some examples, the apparatus includes means for obtaining, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating transmission of power headroom report (PHR), in accordance with various aspects of the present disclosure.

FIG. 5A is a diagram illustrating conditions triggering predictive PHR transmission, in accordance with various aspects of the present disclosure.

FIG. 5B is a diagram illustrating conditions triggering predictive PHR transmission, in accordance with various aspects of the present disclosure.

FIG. 5C is a diagram illustrating conditions triggering predictive PHR transmission, in accordance with various aspects of the present disclosure.

FIG. 6A is a diagram illustrating path loss reference point associated with PHR, in accordance with various aspects of the present disclosure.

FIG. 6B is a gram illustrating path loss reference point associated with PHR, in accordance with various aspects of the present disclosure.

FIG. 7 is a diagram illustrating an example of a hardware implementation for an example apparatus.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating another example of a hardware implementation for another example apparatus.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some of existing techniques for triggering power headroom report (PHR) are based on assumption that a path loss, estimated from channel metric measurements of path loss reference signal, is greater than threshold change from a previously estimated path loss. However, such existing techniques introduce latency for the network entity to alter uplink transmission of the UE, and the latency can be further exacerbated for uplink power control commands transmitted to the UE.

Accordingly, the techniques described herein reduce the latency of uplink power control. In certain aspects, UE may calculate a path loss based on a predicted channel metric of a path loss reference signal and output a predictive PHR based on a set of conditions, where the power headroom (PH) indicated in the PHR is based on the calculated path loss. Additional details of these techniques are described below.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

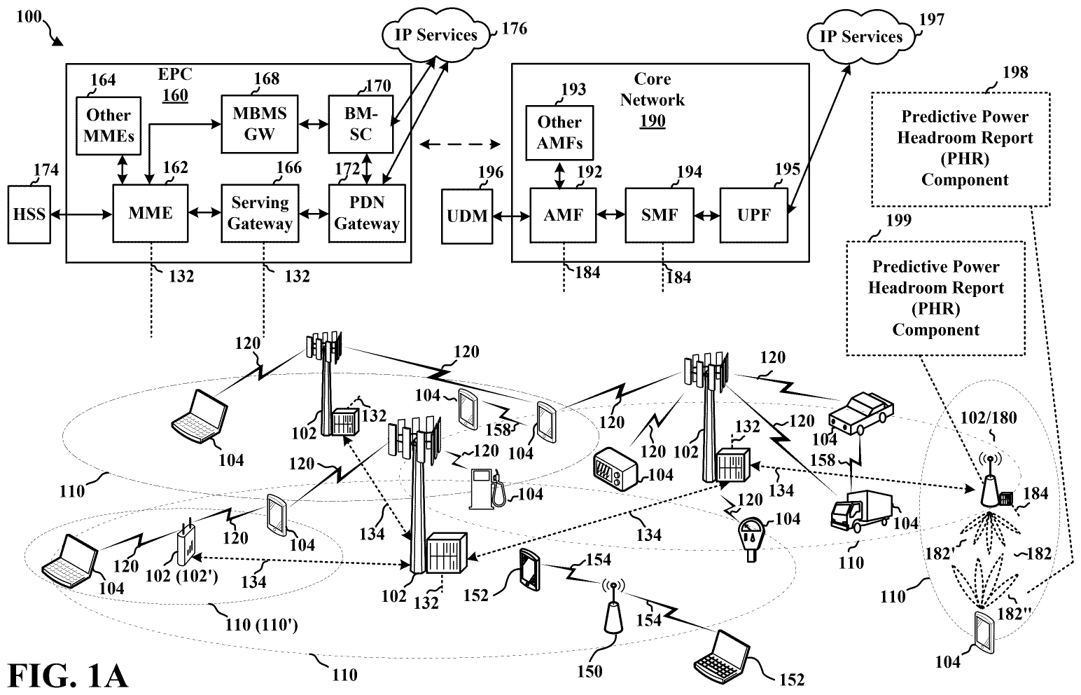

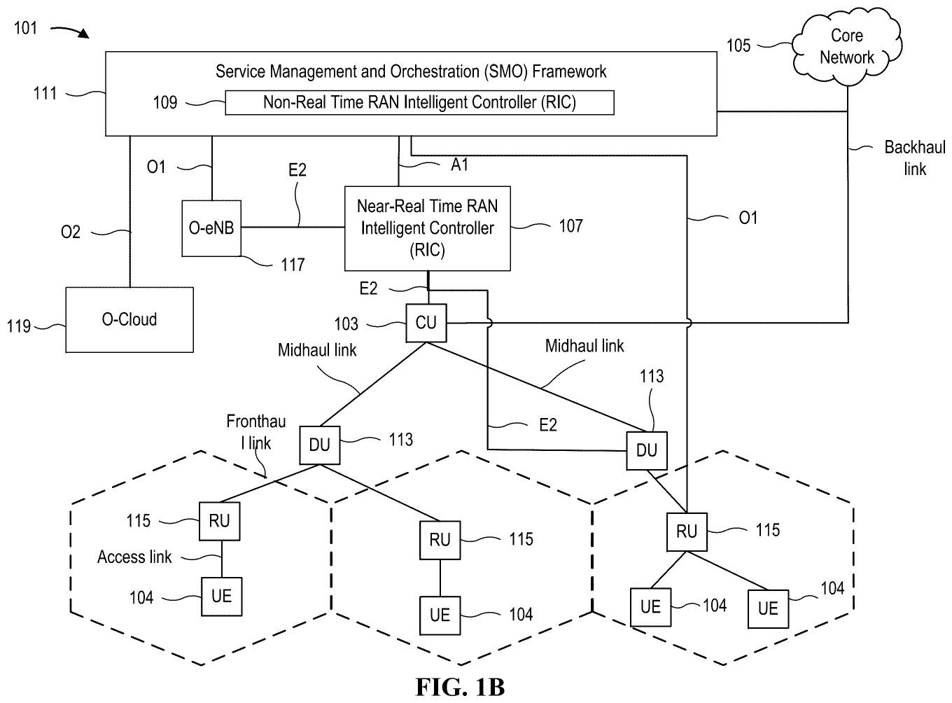

FIG. 1 is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include predictive power headroom report (PHR) component 198, and one or more of the base stations 102/180 may be configured to include a predictive PHR component 199, wherein the predictive PHR component 198 and predictive PHR component 199 are operable to perform techniques for transmitting PHR while reducing latency in altering uplink power control for UE and improving efficiency of the UE and the network entity 102/180.

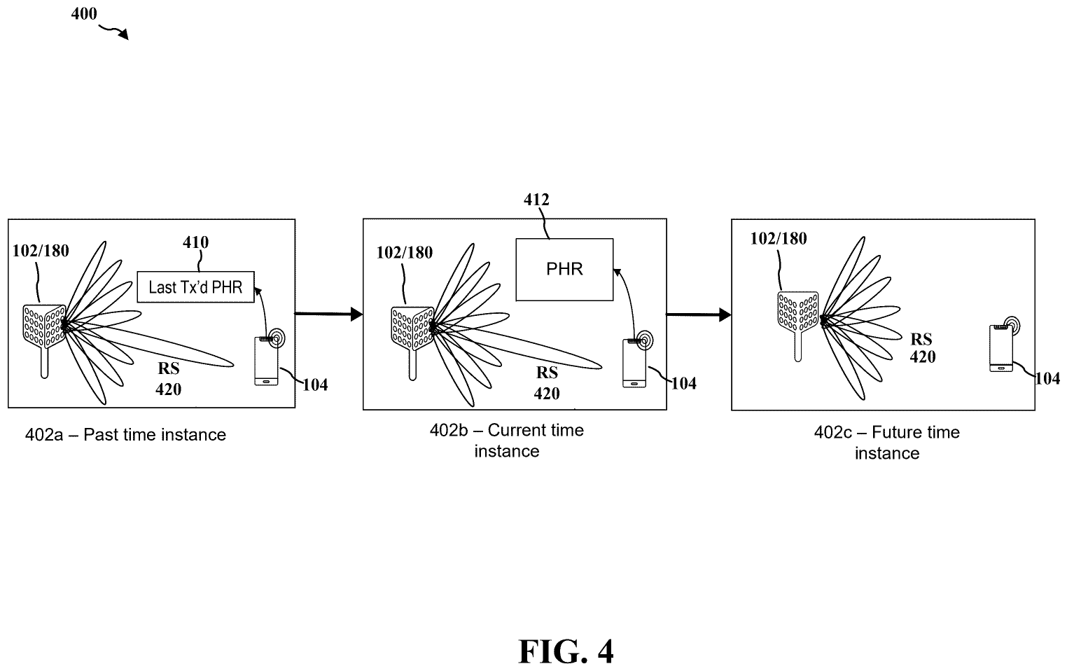

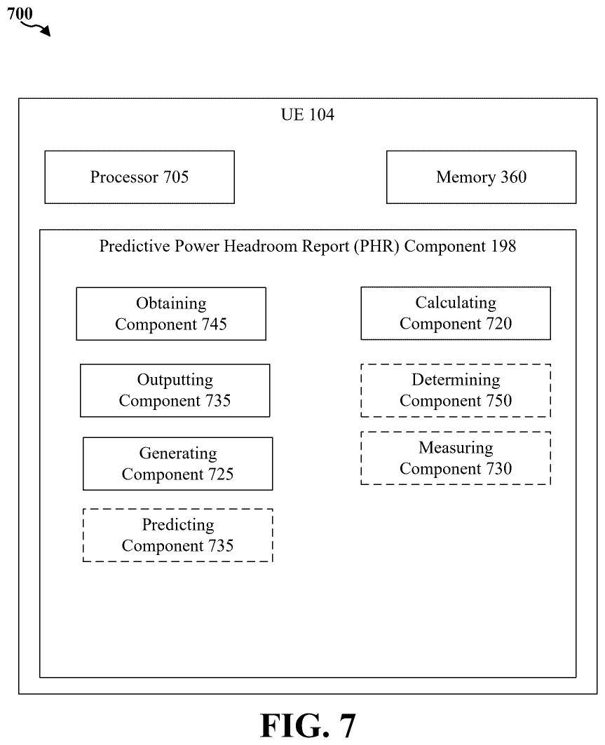

At one or more of the UEs 104, and additionally referring to FIG. 7, the predictive PHR component 198 includes an obtaining component 745 configured to obtain, from a network entity, a reference signal and a configuration indicating a set of one or more parameters. Further, the predictive PHR component 198 includes a calculating component 720 configured to calculate a path loss based on a predicted channel metric of the reference signal. Further, the predictive PHR component 198 includes a generating 725 configured to generate a power headroom report (PHR) based on at least one of the set of one or more parameters, a set of one or more conditions, or the calculated path loss, wherein the PHR indicates at least a power headroom (PH) at a future time instance. Further, the predictive PHR component 198 includes an outputting component 730 configured to output the PHR for transmission to the network entity, the output being based on the set of one or more conditions. Additional details of the obtaining component 745, calculating component 720, generating component 735, outputting component 730 are provided below, for example, with reference to FIGS. 4-12.

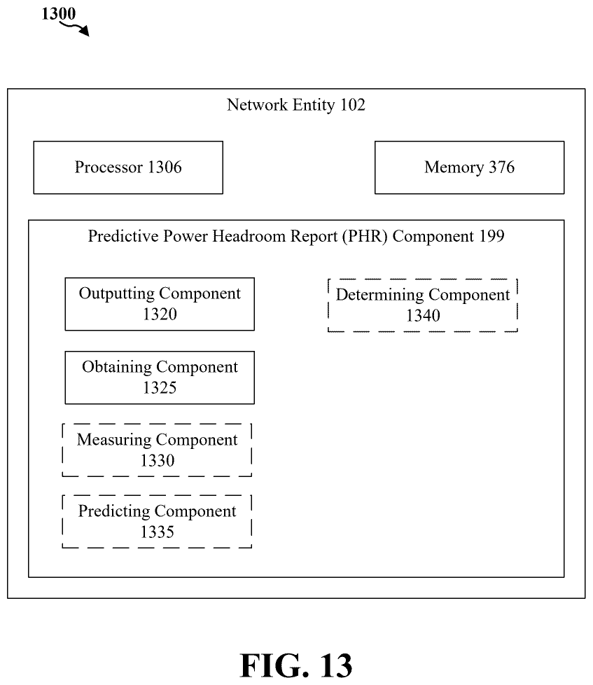

At one or more of the base stations 102/180 (or, network entities), and additionally referring to FIG. 13, the predictive PHR component 199 includes an outputting component 1320 configured to output, for transmission to a user equipment (UE), a reference signal and a configuration indicating a set of one or more parameters. Additionally, the predictive PHR component 199 includes an obtaining component 1325 configured to obtain, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric. Additional details of the outputting component 1320, obtaining component 1325 are provided below, for example, with reference to FIGS. 4-6B, 13-19.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing. beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUS) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming. physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

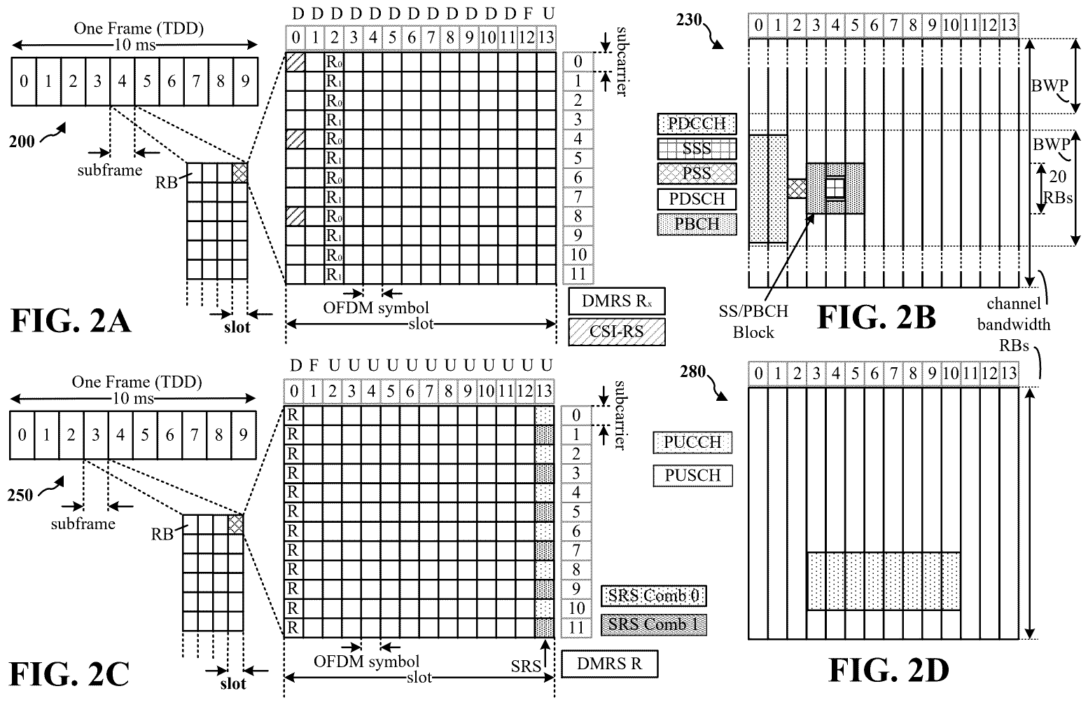

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0), each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios: limited to a single stream transmission). The number of slots within a subframe is based on the slot configuration and the numerology. For slot configuration 0 different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 KHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 KHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

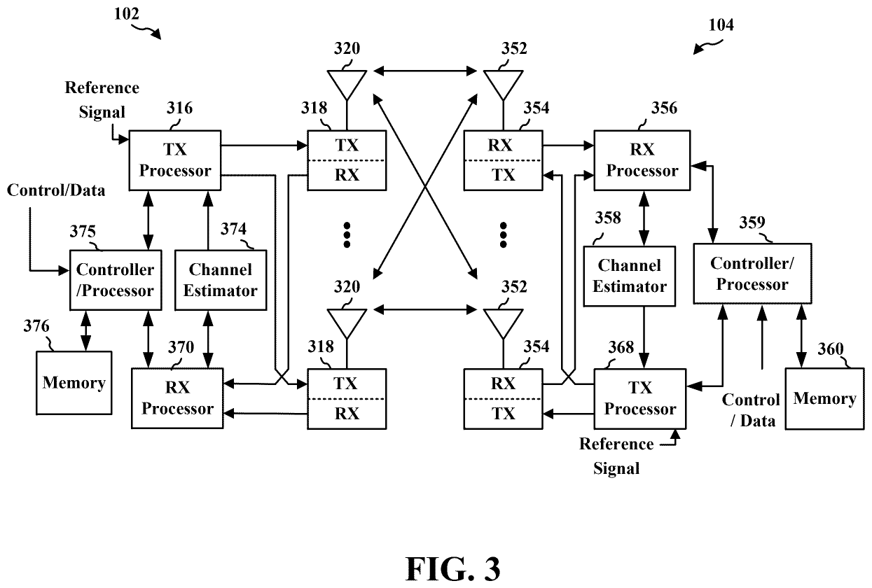

FIG. 3 is a block diagram of hardware components of the base station 102 (or 180) in communication with the UE 104 in the wireless communication network 100. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging. RRC connection establishment, RRC connection modification, and RRC connection release), inter radio access technology (RAT) mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs: and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching. mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs: and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. For example, the memory 360 may include executable instructions defining the predictive PHR component 198. The TX processor 368, the RX processor 356, and/or the controller/processor 359 may be configured to execute the predictive PHR component 198.

At least one of the TX processor 316, the RX processor 370, and the controller/processor 375 may be configured to perform aspects in connection with 199 of FIG. 1. For example, the memory 376 may include executable instructions defining the predictive PHR component 199. The TX processor 316, the RX processor 370, and/or the controller/processor 375 may be configured to execute the predictive PHR component 199.

Referring to example 400 of FIG. 4, a UE 104 may be configured to be triggered to output and/or transmit a predictive PHR based on a set of conditions. A predictive PHR may be a PHR that indicates a power headroom (PH) based on a path loss calculated using a predicted channel metric of a reference signal (e.g., a path loss reference signal (PLRS)). Examples of channel metrics of a reference signal (e.g., PLRS) include, but are not limited to, L1-RSRP, and the like. The predicted channel metric of the reference signal (e.g., PLRS) may be associated with a future time instance. For example, the predicted channel metric may be an estimate of the channel metric (e.g., an estimated L1-RSRP) at a future time instance (e.g., an estimated L1-RSRP value of the PLRS. In some implementations, the PH indicated in the predictive PHR may be based on a transmission power of a time instance associated with the predicted channel metric of the reference signal (e.g., PLRS). In some implementations, the reference signal (e.g., PLRS) for a predictive PHR may be the same reference signal as the reference signal associated with and/or used for generating and/or determining a non-predictive PHR. A non-predictive PHR may be a PHR that indicates a PH based on a path loss calculated using a measured channel metric of a reference signal (e.g., PLRS). In some implementations, a reference signal (e.g., PLRS) for a predictive PHR may be a separately configured reference signal (e.g., PLRS) from the reference signal (PLRS) configured for a non-predictive PHR. In some implementations, the reference signal (e.g., PLRS) for a predictive PHR may be different from a reference signal of a non-predictive PHR. In some implementations, the predictive PHR may be configured with a same or similar format as a non-predictive PHR. In some implementations, the format of a predictive PHR may be configured to be different from format of a non-predictive PHR. In some implementations, the predicted channel metric of the reference signal (e.g., PLRS) may be predicted by the network entity 102 and indicated to the UE 104. In some implementations, the UE 104 may be configured to determine and/or predict a channel metric of the reference signal (e.g., PLRS) based upon which the UE 104 calculates the path loss used in determining the PH for the predictive PHR.

The UE 104 may receive a configuration indicating one or more parameters. The one or more parameters may be associated with and/or for a predictive PHR. For example, the UE 104 may receive the configuration from the network entity 102. In some implementations, the one or more parameters for the predictive PHR may be the same parameters as the parameter(s) for a non-predictive PHR. In some implementations, the one or more parameters may different from the parameters for the non-predictive PHR. Examples of the one or more parameters may include, but are not limited to, phr-ProhibitTimer-PredictBM, phr-Tx-PowerFactorChange-PredictBM, phr-Tx-rsrpConfLevel-PredictBM, and the like.

The UE 104 may transmit the PHRs (e.g., predictive or non-predictive) 410, 412 at different time instances. As shown in FIG. 4, the UE 104 may be configured to transmit PHRs at any of the time instances 402a, 402b, 402c. For example, the UE 104 may transmit PHR 410 at time instance 402a and PHR 412 at time instance 402b. Time instance 402a is a time instance before the time instance 402b and time instance 402c. Time instance 402b is a time instance before the time instance 402c and a time instance after 402a. Time instance 402c is a time instance after time instance 402a and time instance 402b. In some implementations, the PHR 410 may be a non-predictive PHR and may indicate a PH based on a measured channel metric at time instance 402a of the reference signal (e.g. PLRS) 420. In some implementations, the PHR 410 may be a predictive PHR and may indicate a PH based on a predicted channel metric associated with a future instance of time (e.g., time instance 402b or time instance 402c). In some implementations, the PHR 412 may be a non-predictive PHR and may indicate a PH based on a measured channel metric at time instance 402b of the reference signal 420. In some implementations, the PHR 412 may be a predictive PHR and may indicate a PH based on a predicted channel metric of the reference signal 420. The predicted channel metric may be associated with time instance 402c.

As described above, the UE 104 may transmit the predictive PHR based on a set of conditions. An example of a condition from the set of conditions may be that a configured timer value expires or satisfies a threshold timer value (e.g., value of parameter phr-ProhibitTimer-PredictBM). The UE 104 may be configured to reset its timer value when it transmits the predictive PHR. For example, if the PHR 410 transmitted in the time instance 402a is a predictive PHR, the UE 104 may reset the timer in time instance 402a, and at time instance 402b, the UE 104 may determine whether the timer value expired or satisfied the threshold time value (e.g., value of parameter phr-ProhibitTimer-PredictBM). If the UE 104 determines that the timer value satisfies the threshold timer value, then the UE 104 may be configured to transmit the PHR 412, a predictive PHR, at time instance 402b.

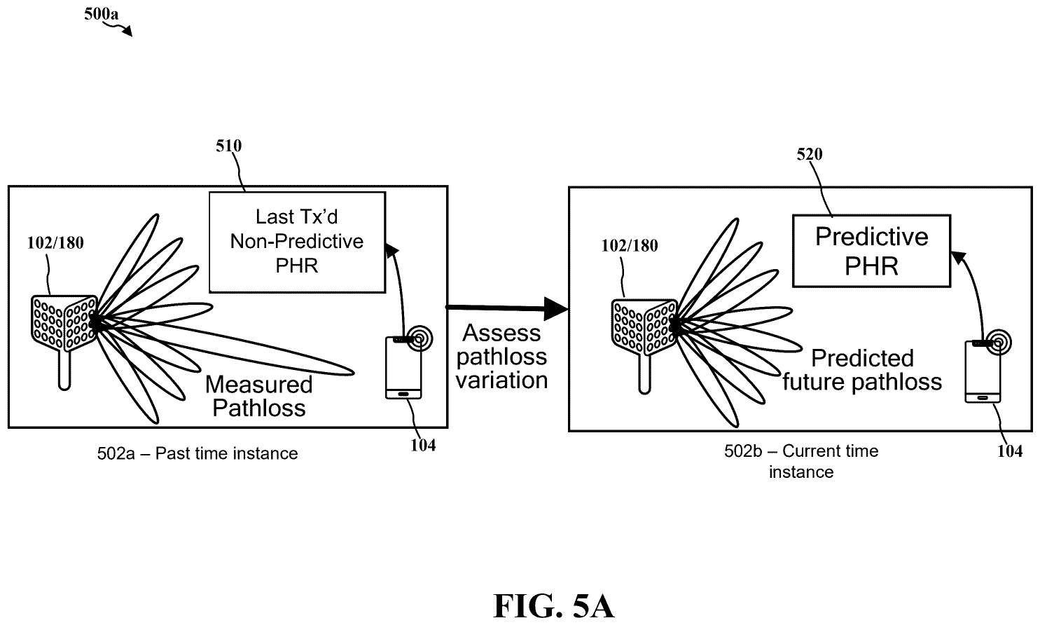

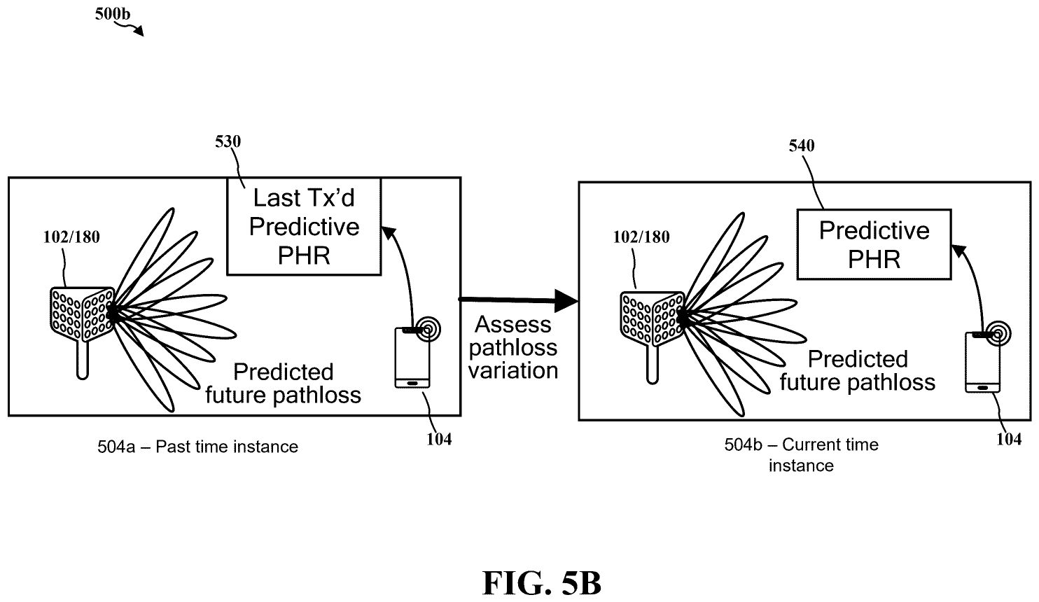

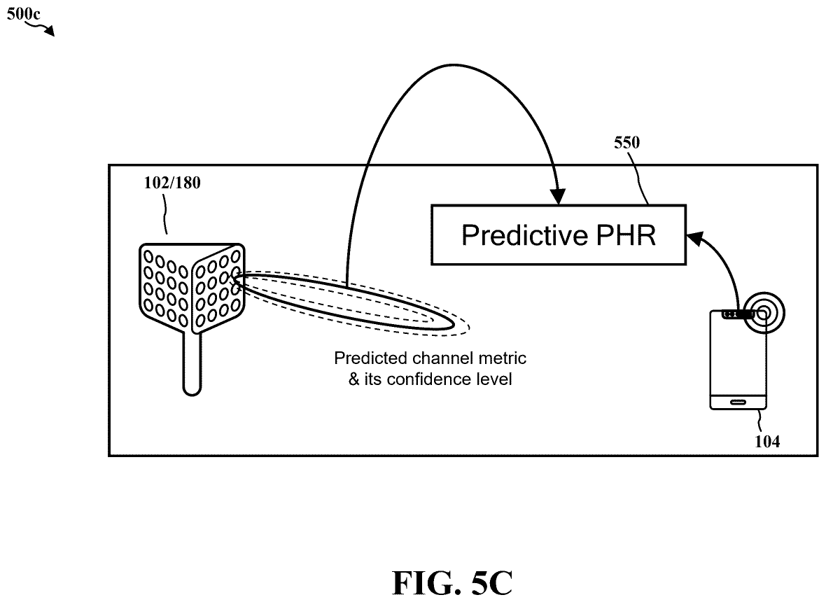

Another example of a condition from the set of conditions may be that a threshold path loss difference (e.g., value of phr-Tx-PowerFactorChange-PredictBM) between a current path loss calculated by the UE 104 using the predicted channel metric of the path loss reference signal and the path loss associated with a previous transmission of the PHR. For example, as shown by example 500a of FIG. 5A, the transmitted PHR at a past time instance 502a may be a non-predictive PHR 510, and the UE 104 may be configured to measure and/or calculate a path loss at the current time instance 502b using a predicted channel metric of a reference signal (e.g., PLRS) received by the UE 104. The UE 104 may calculate a difference between the path loss calculated at time instance 502a and the path loss at time instance 502b. The UE 104 may be configured to transmit the predictive PHR 520, at time instance 502b, when the calculated difference satisfies the threshold path loss difference (e.g., value of phr-Tx-PowerFactorChange-PredictBM). Similarly, as shown by example 500b of FIG. 5B, the transmitted PHR 530 at a past time instance 504a may be a predictive PHR, and the UE 104 may be configured to measure and/or calculate a path loss at the current time instance 504b using a predicted channel metric of a reference signal (e.g., PLRS) received by UE 104. The UE 104 may calculate a difference between the path loss calculated at time instance 504a and the path loss at time instance 504b. The UE 104 may be configured to transmit the predictive PHR 540, at time instance 504b, when the calculated difference satisfies the threshold path loss difference (e.g., value of phr-Tx-PowerFactorChange-PredictBM).

Another example of a condition from the set of conditions may be that the confidence level associated with predicted channel metric of the reference signal (e.g., PLRS) satisfies a threshold confidence level (e.g., value of phr-Tx-rsrpConfLevel-PredictBM) as shown by example 500c of FIG. 5C. The confidence level can be a variance and/or a standard deviation associated with the predicted channel metric (e.g., L1-RSRP) of the path loss-RS. The UE 104 may receive (e.g., from the network entity 102) the confidence level of a predicted channel metric or the UE 104 may determine the confidence level of the predicted channel metric. The UE 104 may be configured to determine the confidence level when the UE 104 predicts the channel metric of the reference signal (e.g., PLRS). The UE 104 may transmit the PHR 550, a predictive PHR, at time instance 506 when the confidence level of the predicted channel metric satisfies a threshold confidence level (e.g., value of phr-Tx-rsrpConfLevel-PredictBM).

In some implementations, the UE 104 may be configured to transmit the predictive PHR when all of the conditions in the set of conditions are satisfied. In some implementations, the UE 104 may be configured to transmit the predictive PHR when a subset of the conditions are satisfied. For example, the UE 104 may be configured to transmit the predictive PHR when the timer satisfies the threshold timer and the different between the path loss at the current time instance and a path loss at a past time instance.

In some implementations, one or more of the conditions of the set of conditions may be activated and/or deactivated by the network entity 102 via signaling from network entity 102. For example, the network entity 102 may transmit a message (e.g., a MAC CE message, a DCI message, and the like) indicating activation or deactivation of the condition of the confidence level of the predicted channel metric satisfying the threshold confidence level of the predicted channel metric.

In some implementations, the network entity 102 may predict the channel metric (e.g., L1-RSRP) of the reference signal (e.g., PLRS) associated with a future time instance and the transmit the predicted channel metric to the UE 104. In some implementation, the network entity 102 may be configured to predict the channel metric associated with a future time instance based on a measured channel metric of the reference signal (e.g., PLRS). For example, the network entity 102 may be configured to measure a channel metric (e.g., L1-RSRP) of the reference signal (e.g., the PLRS) and predict and/or estimate a value of the channel metric at a future time instance based on the measured channel metric. In some implementations, the network entity 102 may be preconfigured with one or more channel metric estimation techniques and/or machine learning models trained to predict and/or estimate channel metric(s) at a future time instance. In some implementations, the output of the machine learning models may be the predicted and/or estimated channel metric at a future time instance. In some implementations, the network entity 102 may be configured to provide the measured channel metric as an input to the machine learning model. The UE 104 may receive the predicted channel metric in a message (e.g., a MAC CE message, a DCI message. and the like), and the message may include one or more of a value of the predicted channel metric, a time instance and/or a time window associated with the predicted channel metric, a confidence level associated with the predicted channel metric (e.g., a variance, a standard-deviation, and/or the like of the predicted value of the L1-RSRP). The UE 104 may be configured to include in the predictive PHR one or more of PH, a confidence level associated with the PH, a time instance and/or time window of when the UE 104 receives the predicted channel metric from the network entity 102, and/or the value of the predicated channel metric received from the network entity 102, the confidence level received from the network entity 102, the time instance and/or window associated with the predicted channel metric received from the network entity 102.

In some implementations, the UE 104 may predict the channel metric of the reference signal (e.g., PLRS). In some implementation, the UE 104 may be configured to predict the channel metric associated with a future time instance based on a measured channel metric of the reference signal (e.g., PLRS). For example, the UE 104 may be configured to measure a channel metric (e.g., L1-RSRP) of the reference signal (e.g., the PLRS) and predict and/or estimate a value of the channel metric at a future time instance based on the measured channel metric. In some implementations, the UE 104 may be preconfigured with one or more channel metric estimation techniques and/or machine learning models trained to predict and/or estimate channel metric(s) at a future time instance. In some implementations, the output of the machine learning models may be the predicted and/or estimated channel metric at a future time instance. In some implementations, the UE 104 may be configured to provide the measured channel metric as an input to the machine learning model. The UE 104 may calculate the path loss using the predicted channel metric, and in the PHR, the UE 104 may include the PH calculated based on the calculated path loss. In some implementations, the PHR may further include a PH confidence level calculated based on the confidence level associated with the predicted channel metric. In some implementations, the PHR may include a value of the predicted channel metric, associated reference signal identifier (ID) (e.g., PLRS ID), confidence level with respect to the predicted channel metric, the time instance and/or window associated w/the predicted channel metric, and the like.

In some implementations, the UE 104 may be configured to transmit a report, separate from the PHR, indicating the predicted channel metric of the reference signal (e.g., PLRS), or the confidence level of the predicted channel metric, and the like. The UE 104 may transmit the report via MAC CE message or a uplink control information (UCI) message. In such implementations, the PHR may include the time instance at which the UE 104 transmits the report indicating the predicted channel metric of the reference signal (e.g., PLRS). In some implementations, the network entity 102 may transmit a message to the UE 104 to instruct and/or cause the UE 104 to update an uplink transmit power of the UE 104 for the time instance associated with the predicted channel metric based on the PH indicated in the PHR that the network entity 102 receives from the UE 104. In some implementations, the network entity 102 may be configured to identify and/or determine the time instance for which the uplink transmit power should be updated based on a determination that the PH indicated in the PHR is associated with the time instance associated with a predicted channel metric. For example, if the PH indicated in the PHR is based on a predicated channel metric, then the PH is associated with the same time instance with which the predicted channel metric is associated. In some implementations, the UE 104 may receive the message instructing and/or indicating an updated uplink transmit power, and, at the time instance associated with the predicated channel metric, the UE 104 may transmit data using the updated uplink transmit power.

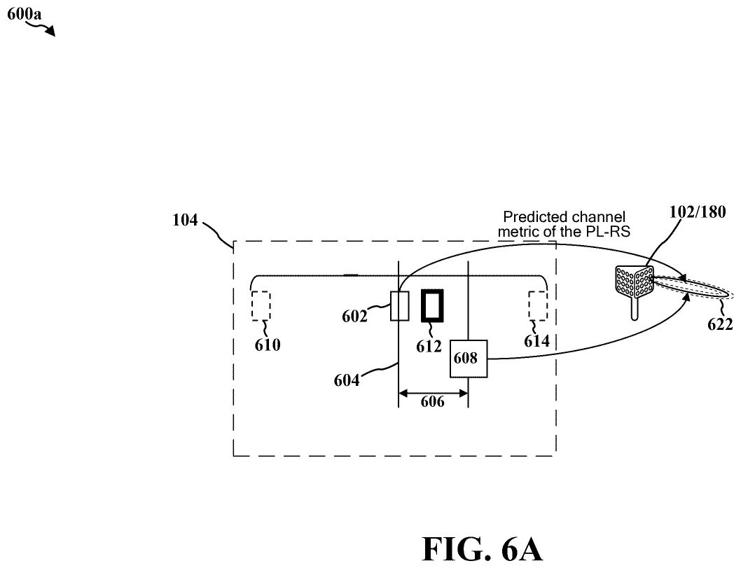

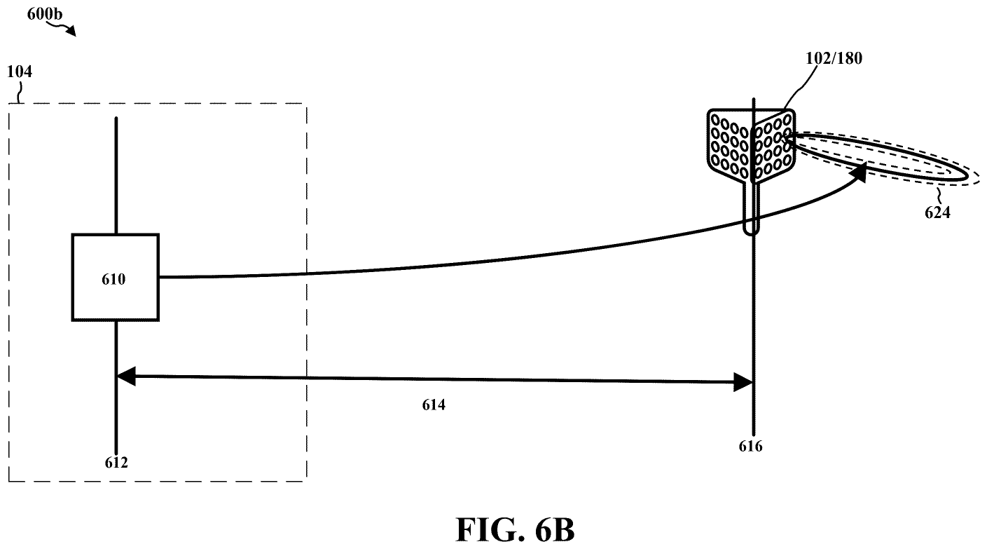

Referring now to example 600a of FIG. 6A, there is shown an example path loss reference point agreement between the UE 104 and the network entity 102. In implementations, where the network entity indicates the predicted channel metric of the reference signal (e.g., PLRS), then the path loss associated with the predictive PHR 608 may be associated with a time instance indicated in the message comprising or indicating the predicted channel metric. The UE 104 may be configured to transmit the predictive PHR 608 within a threshold time duration 606 (e.g., threshold number (K) of slots, and the like) from the time instance 604 at which the predicted channel metric 602 of the reference signal 622 (e.g., PLRS) is received from the network entity 102. The predicted channel metrics 610, 612, 614 are not within the threshold time duration 606. The channel metric 610 is predicted at a time instance before the time instance 604, the time instance at which the channel metric 602 is predicted. The channel metrics 612 and 614 are predicted at time instances after the time instance 604.

Similarly, in implementations where the UE 104 is configured to predict the channel metric of the reference signal (e.g., PLRS), the path loss associated with the predictive PHR 608 may be associated with a time instance indicated in the message indicated the predicted channel metric. The UE 104 may be configured to transmit the predictive PHR 608 within a threshold time duration 606 (e.g., threshold number (K) of slots, and the like) from the time instance 604 at which the UE 104 predicts the channel metric 602.

The UE 104 may be preconfigured with the threshold time duration 606. In some implementations, the network entity 102 may define the threshold time duration 606 and transmit the threshold time duration 606 in a message (e.g., an RRC message, a MAC CE message, a DCI message, and the like). In some implementations, the UE 104 may indicate and/or report the threshold time duration 606.

Referring now to 600b of FIG. 6B, there is shown an example path loss reference point agreement between the UE 104 and the network entity 102 when the UE predicts the channel metric of the reference signal 624 (e.g., PLRS). The UE 104 may be configured to associate, the calculated path loss associated with the predictive PHR 610, a time instance 616 that is a threshold time duration 614 after the time instance 612 at which the predictive PHR 610 is transmitted. The UE 104 may be preconfigured with the threshold time duration 614. In some implementations, the network entity 102 may define the threshold time duration 606 and transmit the threshold time duration 606 in a message (e.g., an RRC message, a MAC CE message, a DCI message, and the like). In some implementations, the UE 104 may indicate and/or report the threshold time duration 606.

As described above, the UE 104 may be configured to calculate and/or determine a PH indicated in the predictive PHR may be based on a transmission power. The transmission power may be a UE configured maximum output power, P_{cMAX, f, c} (i). In some implementations, the UE 104 may be configured to determine the UE configured maximum output power at time instance and/or window (e.g., a slot) associated with transmission of the PHR.

In some implementations, the UE 104 may be configured to determine the UE configured maximum output power at a time instance associated with the predicted channel metric. In implementations where the predicted channel metric is received (e.g., from network entity 102) by the UE 104, the UE 104 may determine the UE configured maximum output power at a time instance associate with the received predicted channel metric. For example, if the message indicating the predicted channel metric is received at slot K, and the message indicates that the predicted channel metric is associated with a time slot of K+N, then the UE 104 determines the UE configured maximum output power is associated with the time slot of K+N. In implementations, where the UE 104 predicts the channel metric of the reference signal (e.g., PLRS), the UE configured maximum output power is associated with the time instance associated with the predicted channel metric. For example, if the UE 104 predicts the channel metric in slot K, and the value of the predicted channel metric is associated with a time slot K+N, then UE configured maximum output power used by the UE 104 in determining the predictive PH is also associated with the slot K+N.

As described above, in some implementations, the UE 104 may be configured with different parameters for non-predictive PHR and predictive PHR. In such implementations, the UE 104 may be configured with different sets of conditions for non-predictive PHR and predictive PHR. In such implementations, the UE 104 may be configured to transmit only type of the PHRs. For example, the UE 104 may be configured to transmit either only a predictive PHR or a non-predictive PHR. In some implementations, the network entity 102 may indicate the type of PHR the UE 104 can transmit to the network entity 102. In some implementations, the network entity 102 may transmit a UE recommendation for a PHR type to the network entity 102. In some implementations, the reference signals (e.g., PLRSs) for non-predictive PHRs may be different from reference signals (e.g., PLRSs) for predictive PHRs.

In some implementations, a non-predictive PHR and a predictive PHR may be jointly triggered at the UE 104. In such implementations, the UE 104 may be configured with the same set of parameters for non-conventional PHR and predictive PHR. Examples of such parameters may include, but are not limited to, phr-ProhibitTimer, phr-Tx-PowerFactorChange, and the like. In such implementations, the UE 104 may be configured with the same sets of conditions for non-predictive PHR and predictive PHR. In such implementations, the UE 104 may be configured to transmit both type of the PHRs. The UE 104 may indicate a type of a transmitted PHR in a message associated with the transmitted PHR. For example a bit in a MAC CE message may indicate whether the transmitted PHR is a predictive PHR or non-conventional PHR.

In some implementations, the UE 104 may be configured to transmit a capability indication to the network entity 102. The capability indication may indicate whether the UE 104 is configured to transmit predictive PHR. The UE 104 may a set of parameters and/or a set of conditions for predictive PHRs from the network entity 102 in response to the UE 104 transmitting the capability indication.

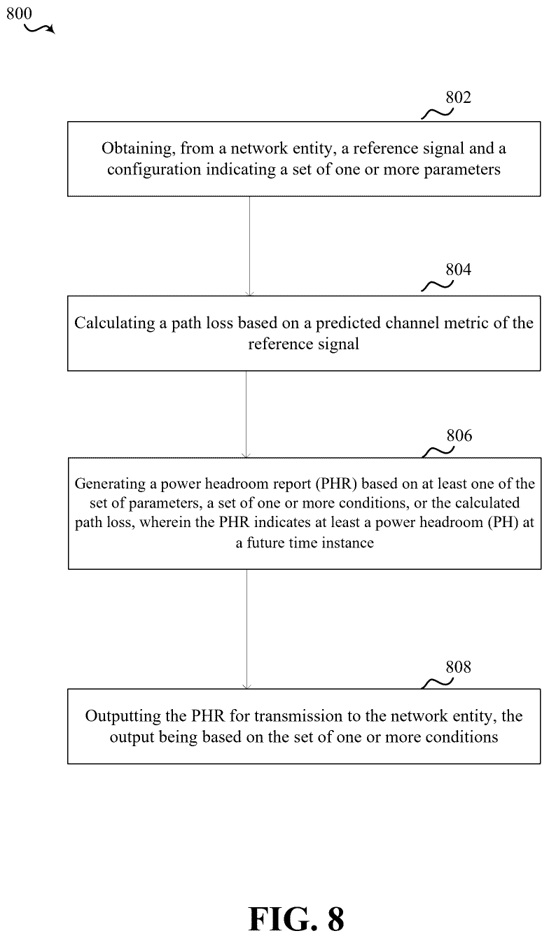

Referring to FIG. 7 and FIG. 8, in operation, UE 104 may perform a method 800 of wireless communication, by such as via execution of predictive PHR component 198 by processor 705 and/or memory 360 (FIG. 3). In this case, the processor 705 may be the receive (rx) processor 356, the controller/processor 359, and/or the transmit (tx) processor 368 described above in FIG. 3.

At block 802, the method 800 includes obtaining, from a network entity, a reference signal and a configuration indicating a set of one or more parameters. For example, in an aspect, means for obtaining, from a network entity, a reference signal and a configuration indicating a set of one or more parameters may be configured as or may comprise at least one of UE 104, processor 705, memory 360, predictive PHR component 198, and/or obtaining component 745.

For example, the obtaining at block 802 may include obtaining the reference signal and the configuration via a wireless signal at an antenna or antenna array (e.g., antenna 352) as described in FIG. 3, and processes the wireless signals as described in FIG. 3.

At block 804, the method 800 includes calculating a path loss based on a predicted channel metric of the reference signal. For example, in an aspect, means for calculating a path loss based on a predicted channel metric of the reference signal may be configured as or may comprise at least one of UE 104, processor 705, memory 360, predictive PHR component 198, and/or calculating component 720.

At block 806, the method 800 includes generating a power headroom report (PHR) based on at least one of the set of one or more parameters, a set of one or more conditions, or the calculated path loss, wherein the PHR indicates at least a power headroom (PH) at a future time instance. For example, in an aspect, means for generating a power headroom report (PHR) based on at least one of the set of one or more parameters, a set of one or more conditions, or the calculated path loss, wherein the PHR indicates at least a power headroom (PH) at a future time instance may be configured as or may comprise at least one of UE 104, processor 705, memory 360, predictive PHR component 198, and/or generating component 725.

At block 808, the method 800 includes outputting the PHR for transmission to the network entity, the output being based on the set of one or more conditions. For example, in an aspect, means for outputting the PHR for transmission to the network entity, the output being based on the set of one or more conditions may be configured as or may comprise at least one of UE 104, processor 705, memory 360, predictive PHR component 198, and/or outputting component 735.

For example, the outputting at block 808 may include outputting the PHR via a wireless signal at an antenna or antenna array (e.g., antenna 352) as described in FIG. 3.

In alternative or additional aspect, the set of one or more parameters indicate at least one of a threshold timer, a threshold difference in path loss, or a threshold confidence level associated with the predicted channel metric of the reference signal.

In alternative or additional aspect, the set of conditions indicate that the predictive PHR is outputted based on a current timer satisfying the threshold timer.

In alternative or additional aspect, the set of conditions indicate that the predictive PHR is outputted based on a difference between the calculated path loss and a path loss associated with a previously outputted PHR satisfies the threshold difference in path loss.

In alternative or additional aspect, the previously outputted PHR indicates a second PH based on the path loss associated with the previously outputted PHR, and wherein the path loss associated with the previously outputted PHR is based on a measured channel metric of a reference signal associated with the previously outputted PHR.

In alternative or additional aspect, the previously outputted PHR indicates a second PH based on the path loss associated with the previously outputted PHR, and wherein the path loss associated with the previously outputted PHR is based on a predicted channel metric of a reference signal associated with the previously outputted PHR.

In alternative or additional aspect, the set of conditions indicate that the PHR is outputted for transmission based on a confidence level associated with the predicted channel metric satisfying the threshold confidence level.

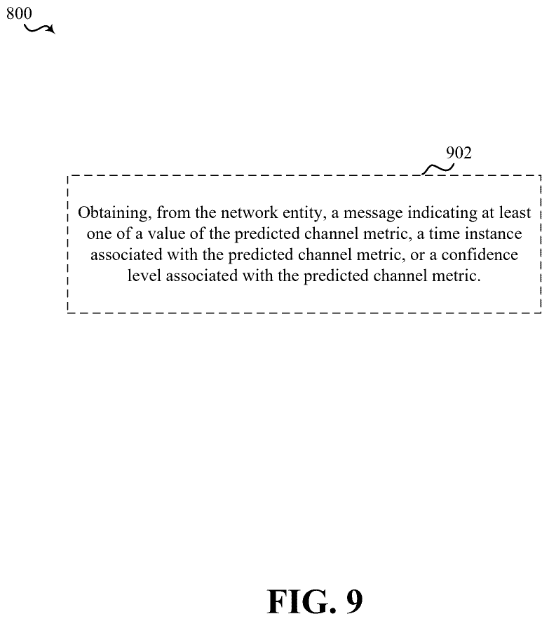

Referring to FIG. 9, in an alternative or additional aspect, at block 902, the method 800 may further include obtaining, from the network entity, a message indicating at least one of a value of the predicted channel metric, a time instance associated with the predicted channel metric, or a confidence level associated with the predicted channel metric. For example, in an aspect, means for obtaining, from the network entity, a message indicating at least one of a value of the predicted channel metric, a time instance associated with the predicted channel metric, or a confidence level associated with the predicted channel metric may be configured as or may comprise at least one of UE 104, processor 705, memory 360, predictive PHR component 198, and/or obtaining component 745.

For example, the obtaining at block 902 may include obtaining the message via a wireless signal at an antenna or antenna array (e.g., antenna 352) as described in FIG. 3.

In alternative or additional aspect, the message is a medium access control control element (MAC CE) message or a downlink control information (DCI) message.

In alternative or additional aspect, the PHR further indicates at least one of a confidence level associated with the PH, a second time instance at which the message is obtained, or the value of the predicted channel metric.

In alternative or additional aspect, the confidence level associated with the PH is based on the confidence level associated with the predicted channel metric.

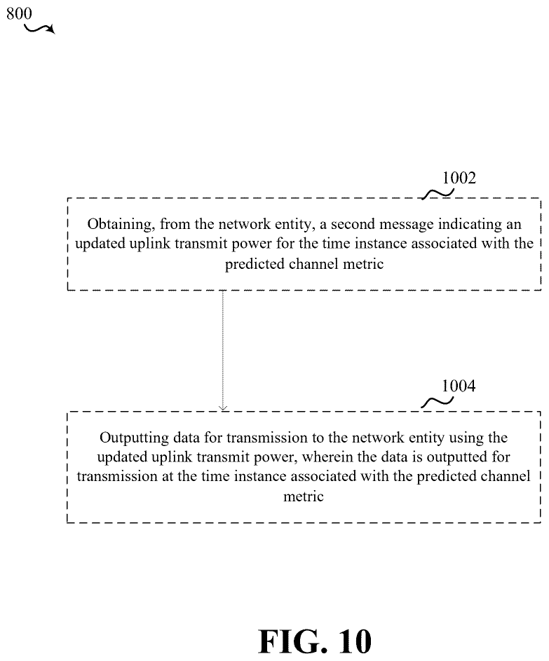

Referring to FIG. 10, in an alternative or additional aspect, at block 1002, where the message indicating at least one of a value of the predicted channel metric, a time instance associated with the predicted channel metric, or a confidence level associated with the predicted channel metric is obtained, the method 800 may further include obtaining, from the network entity, a second message indicating an updated uplink transmit power for the time instance associated with the predicted channel metric. For example, in an aspect, means for obtaining from the network entity, a second message indicating an updated uplink transmit power for the time instance associated with the predicted channel metric may be configured as or may comprise at least one of UE 104, processor 705, memory 360, predictive PHR component 198, and/or obtaining component 745.

For example, the obtaining at block 1002 may include obtaining the second message via a wireless signal at an antenna or antenna array (e.g., antenna 352) as described in FIG. 3.

In the alternative or additional aspect, at block 1004, the method 800 may further include outputting data for transmission to the network entity using the updated uplink transmit power, wherein the data is outputted for transmission at the time instance associated with the predicted channel metric. For example, in an aspect, means for outputting data for transmission to the network entity using the updated uplink transmit power, wherein the data is outputted for transmission at the time instance associated with the predicted channel metric may be configured as or may comprise at least one of UE 104, processor 705, memory 360, predictive PHR component 198, and/or outputting component 735.

For example, the outputting at block 1004 may include outputting the data via a wireless signal at an antenna or antenna array (e.g., antenna 352) as described in FIG. 3.

In alternative or additional aspect, the PHR further indicates at least one of a confidence level associated with the PH, a value of the predicted channel metric, a confidence level associated with predicted channel metric, or a time instance associated with the predicted channel metric.

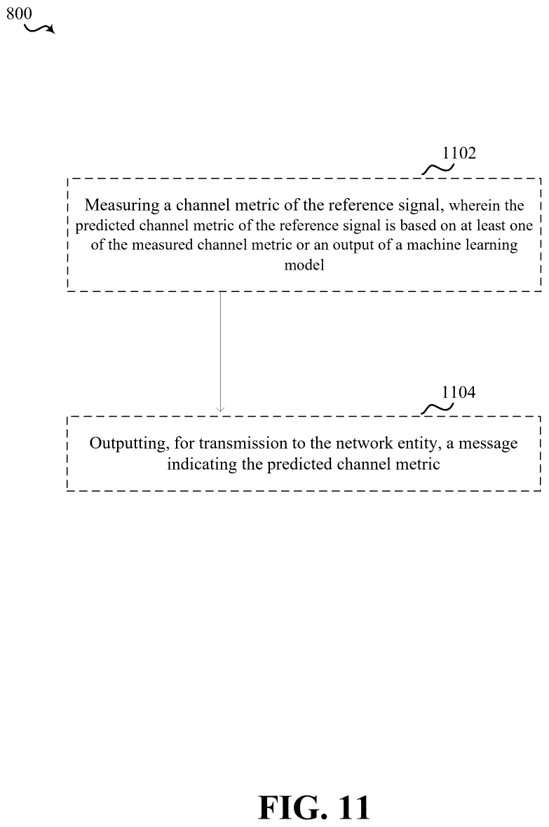

Referring to FIG. 11, in an alternative or additional aspect, at block 1102, the method 800 may further include measuring a channel metric of the reference signal, where the predicted channel metric of the reference signal is based on at least one of the measured channel metric or an output of a machine learning model. For example, in an aspect, means for measuring a channel metric of the reference signal, where the predicted channel metric of the reference signal is based on at least one of the measured channel metric or an output of a machine learning model, may be configured as or may comprise at least one of UE 104, processor 705, memory 360, predictive PHR component 198, and/or measuring component 730.

In the alternative or additional aspect, at block 1104, the method 800 may further include outputting, for transmission to the network entity, a message indicating the predicted channel metric. For example, in an aspect, means for outputting, for transmission to the network entity, a message indicating the predicted channel metric may be configured as or may comprise at least one of UE 104, processor 705, memory 360, predictive PHR component 198, and/or outputting component 735.

For example, the outputting at block 1104 may include outputting the message via a wireless signal at an antenna or antenna array (e.g., antenna 352) as described in FIG. 3.

In alternative or additional aspect, the PHR further indicates a time instance associated with the message, wherein the time instance associated with the message is before a time instance at which the PHR is outputted.

In alternative or additional aspect, the message is a medium access control control element (MAC CE) message or an uplink control information (UCI) message.

In alternative or additional aspect, a time instance at which the PHR is outputted is within a threshold time duration starting from a time instance at which the message is outputted.

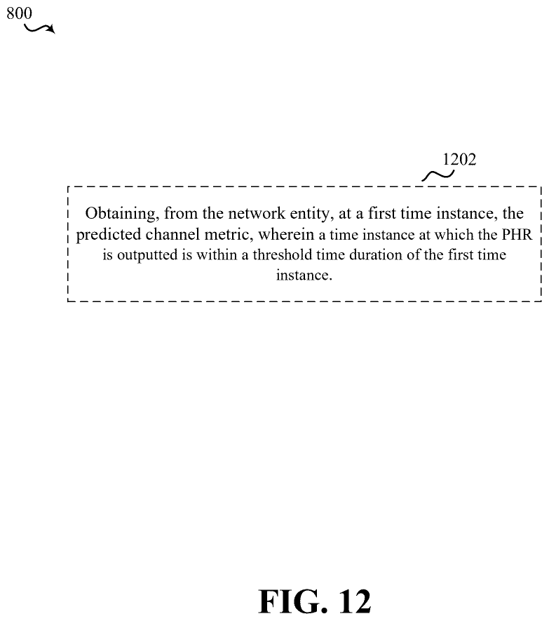

Referring to FIG. 12, in an alternative or additional aspect, at block 1202, the method 800 may further include obtaining, from the network entity, at a first time instance, the predicted channel metric, wherein a time instance at which the PHR is outputted is within a threshold time duration starting from the first time instance. For example, in an aspect, means for obtaining, from the network entity, at a first time instance, the predicted channel metric, wherein a time instance at which the PHR is outputted is within a threshold time duration starting from the first time instance may be configured as or may comprise at least one of UE 104, processor 705, memory 360, predictive PHR component 198, and/or obtaining component 745.

For example, the obtaining at block 1202 may include obtaining the message via a wireless signal at an antenna or antenna array (e.g., antenna 352) as described in FIG. 3.

In alternative or additional aspect, the calculated path loss is associated with a first time instance, wherein the first time instance occurs after a threshold time duration that is after a time instance at which the PHR is outputted.

In alternative or additional aspect, the calculated path loss is associated with a first time instance, wherein the first time instance is a threshold time duration after the first time instance.

In alternative or additional aspect, the PH is based on a maximum transmit power of the apparatus at the current time instance.

In alternative or additional aspect, the PH is based on a maximum transmit power of the apparatus, wherein the maximum transmit power is associated with a first time instance, and the first time instance is a same time instance associated with the predicted channel metric.

In alternative or additional aspect, the set of one or more parameters for the predictive PHR are different from a set of one or more parameters for a non-predictive PHR, and wherein the set of conditions for the predictive PHR are different from a set of conditions for the non-predictive PHR.

In alternative or additional aspect, the set of one or more parameters for the predictive PHR are different from a set of one or more parameters for a non-predictive PHR, and wherein the set of conditions for the predictive PHR are different from a set of conditions for the non-predictive PHR.

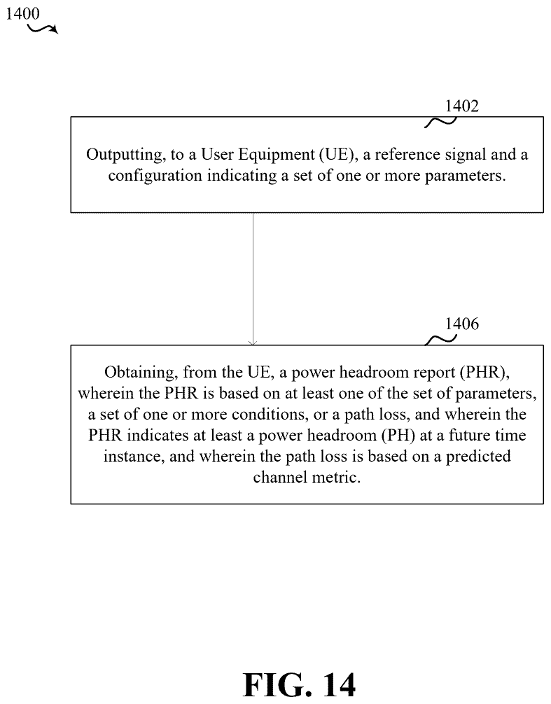

Referring to example 1300 of FIG. 13 and FIG. 14, in operation, network entity 102 may perform a method 1400 of wireless communication, by such as via execution of predictive PHR component 199 by processor 1306 and/or memory 376 (FIG. 3). In this case, the processor 1306 may be the receive (rx) processor 370, the controller/processor 375, and/or the transmit (tx) processor 316 described above in FIG. 3.

At block 1402, the method 1400 includes outputting, to a User Equipment (UE), a reference signal and a configuration indicating a set of one or more parameters. For example, in an aspect, means for outputting, to a UE, a reference signal and a configuration indicating a set of one or more parameters may be configured as or may comprise at least one of network entity 102, processor 1306, memory 376, predictive PHR component 199, and/or outputting component 1320.

For example, the outputting at block 1402 may include outputting the reference signal and the configuration via one or more wireless signals transmitted using an antenna or an antenna array (e.g., antenna 320).

At block 1404, the method 1400 includes obtaining, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric. For example, in an aspect, means for obtaining, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric may be configured as or may comprise at least one of network entity 102, processor 1306, memory 376, predictive PHR component 199, and/or obtaining component 1325.

For example, the obtaining at block 1404 may include obtaining or receiving the PHR via one or more wireless signals at an antenna or an antenna array (e.g., antenna 320) as described in FIG. 3, and processes the wireless signals as described in FIG. 3.

In alternative or additional aspect, the set of one or more parameters indicate at least one of a threshold timer, a threshold difference in path loss, or a threshold confidence level associated with the predicted channel metric of the reference signal.

In alternative or additional aspect, the set of conditions indicate at least one of a timer of the UE satisfying the threshold timer, a difference between the path loss and a path loss associated with a previously obtained PHR satisfying a threshold difference in path loss, or a confidence level associated with the predicted channel metric satisfying the threshold confidence level.

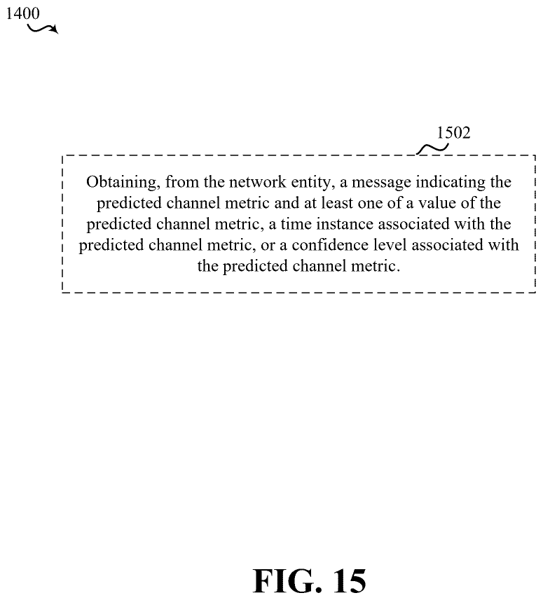

Referring to FIG. 15, in an alternative or additional aspect, at block 1502, the method 1400 may further include outputting, to the UE, a message indicating at least one of a value of the predicted channel metric, a time instance associated with the predicted channel metric, or a confidence level associated with the predicted channel metric. For example, in an aspect, means for outputting, to the UE, a message indicating at least one of a value of the predicted channel metric, a time instance associated with the predicted channel metric, or a confidence level associated with the predicted channel metric may be configured as or may comprise at least one of network entity 102, processor 1306, memory 376, predictive PHR component 199, and/or outputting component 1320.

For example, the outputting at block 1502 may include outputting the message via one or more wireless signals transmitted using an antenna or an antenna array (e.g., antenna 320).

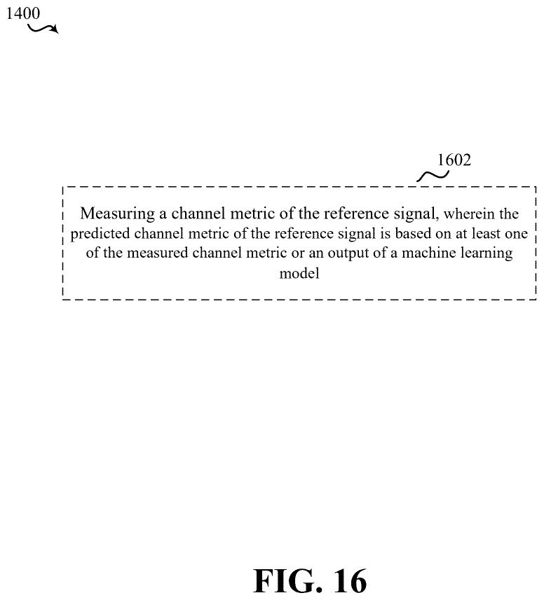

Referring to FIG. 16, in an alternative or additional aspect, at block 1602, where the message indicating at least one of a value of the predicted channel metric, a time instance associated with the predicted channel metric, or a confidence level associated with the predicted channel metric is outputted, the method 1400 may further include measuring a channel metric of the reference signal, wherein the predicted channel metric of the reference signal is based on at least one of the measured channel metric or an output of a machine learning model. For example, in an aspect, means for measuring a channel metric of the reference signal, wherein the predicted channel metric of the reference signal is based on at least one of the measured channel metric or an output of a machine learning model may be configured as or may comprise at least one of network entity 102, processor 1306, memory 376, predictive PHR component 199, and/or measuring component 1330.

In alternative or additional aspect, the message is a medium access control control element (MAC CE) message or a downlink control information (DCI) message.

In alternative or additional aspect, the PHR further indicates at least one of a confidence level associated with the PH, a second time instance at which the message is outputted, or the value of the predicted channel metric.

In alternative or additional aspect, the confidence level associated with the PH is based on the confidence level associated with the predicted channel metric.

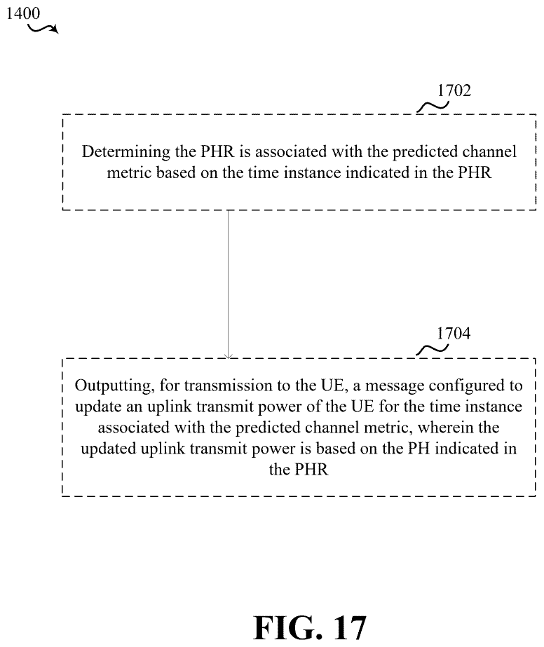

Referring to FIG. 17, in an alternative or additional aspect, at block 1702, where the PHR further indicates at least one of a confidence level associated with the PH, a second time instance at which the message is outputted, or the value of the predicted channel metric, the method 1400 may further include determining that the PH indicated in the PHR is associated with the time instance associated with the predicted channel metric, the determination being based on the second time instance indicated in the PHR. For example, in an aspect, means for determining the PHR is associated with the predicted channel metric based on the time instance indicated in the PHR may be configured as or may comprise at least one of network entity 102, processor 1306, memory 376, predictive PHR component 199, and/or determining component 1340.

In the alternative or additional aspect, at block 1704, the method 1400 may further include outputting, for transmission to the UE, a second message configured to update an uplink transmit power of the UE for the time instance associated with the predicted channel metric, wherein the updated uplink transmit power is based on the PH indicated in the PHR. For example, in an aspect, means for outputting, for transmission to the UE, a second message configured to update an uplink transmit power of the UE for the time instance associated with the predicted channel metric, wherein the updated uplink transmit power is based on the PH indicated in the PHR may be configured as or may comprise at least one of network entity 102, processor 1306, memory 376, predictive PHR component 199, and/or outputting component 1320.

For example, the outputting at block 1704 may include outputting the second message via one or more wireless signals transmitted using an antenna or an antenna array (e.g., antenna 320).

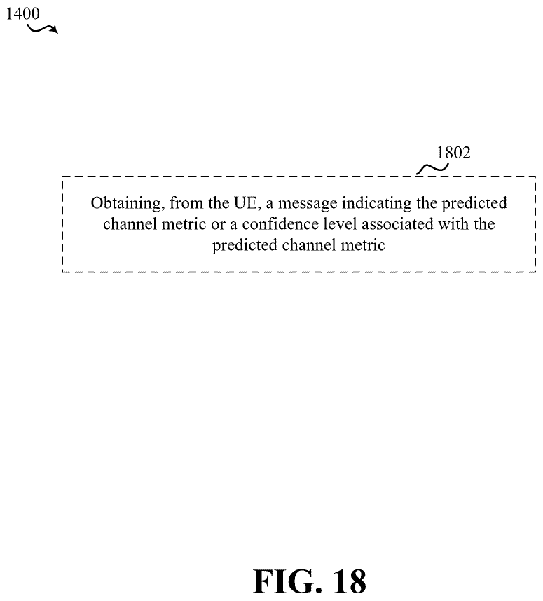

Referring to FIG. 18, in an alternative or additional aspect, at block 1802, the method 1400 may further include obtaining, from the UE, a message indicating the predicted channel metric or a confidence level associated with the predicted channel metric. For example, in an aspect, means for obtaining, from the UE, a message indicating the predicted channel metric or a confidence level associated with the predicted channel metric may be configured as or may comprise at least one of network entity 102, processor 1306, memory 376, predictive PHR component 199, and/or obtaining component 1325.

For example, the obtaining at block 1802 may include obtaining the message via one or more wireless signals at an antenna or an antenna array (e.g., antenna 320) as described in FIG. 3, and processes the wireless signals as described in FIG. 3.

In alternative or additional aspect, the predictive PHR further indicates a time instance associated with the message, wherein the time instance associated with the message is before the current time instance.

In alternative or additional aspect, the message is a medium access control control element (MAC CE) message or an uplink control information (UCI) message.

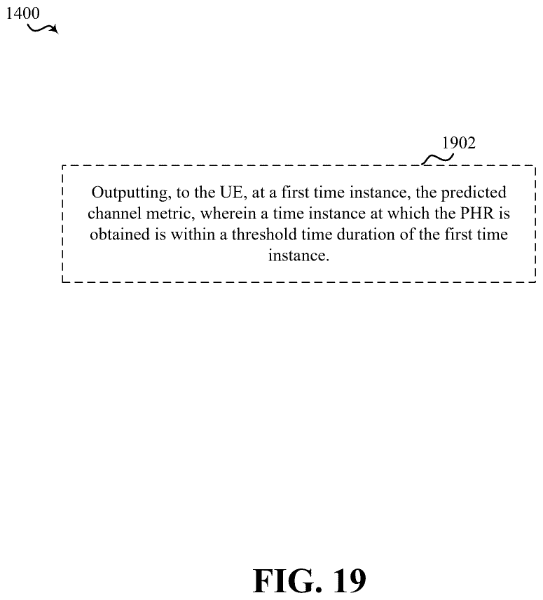

Referring to FIG. 19, in an alternative or additional aspect, at block 1702, the method 1400 may further include outputting, to the UE, at a first time instance, the predicted channel metric, wherein a time instance at which the PHR is obtained is within a threshold time duration starting from the first time instance. For example, in an aspect, means for outputting, to the UE, at a first time instance, the predicted channel metric, wherein a time instance at which the PHR is obtained is within a threshold time duration starting from the first time instance may be configured as or may comprise at least one of network entity 102, processor 1306, memory 376, predictive PHR component 199, and/or outputting component 1320.

For example, the outputting at block 1902 may include outputting the predicted channel metric via one or more wireless signals transmitted using an antenna or an antenna array (e.g., antenna 320).

In alternative or additional aspect, the path loss is associated with a first time instance, wherein the first time instance is a threshold time duration after the first time instance.

In alternative or additional aspect, the PH is based on a maximum output power of the apparatus at the current time instance.

In alternative or additional aspect, the PH is based on a maximum output power of the UE, wherein the maximum output power is associated with a first time instance, and the first time instance is a same time instance associated with the predicted channel metric.

In alternative or additional aspect, the set of parameters for the predictive PHR are different from a set of parameters for a non-predictive PHR, and wherein the set of conditions for the predictive PHR are different from a set of conditions for the non-predictive PHR.

In alternative or additional aspect, the set of parameters for the predictive PHR are the same as a set of parameters for a non-predictive PHR, and wherein the set of conditions for the predictive PHR are the same as a set of conditions for the non-predictive PHR.

Means for receiving or means for obtaining may include a receiver (such as the receive processor 338) or an antenna(s) 334 of the BS 110 or the receive processor 358 or antenna(s) 352 of the UE 120 illustrated in FIG. 3. Means for transmitting or means for outputting may include a transmitter (such as the transmit processor 320) or an antenna(s) 334 of the BS 110 or the transmit processor 364 or antenna(s) 352 of the UE 120 illustrated in FIG. 3. Means for generating, means for calculating, means for measuring, means for predicting, means for determining, means for forwarding, means for detecting, and/or means for performing may include a processing system, which may include one or more processors, such as the receive processor 338/358, the transmit processor 320/364, the TX MIMO processor 330/366, or the controller 340/380 of the BS 110 and the UE 120 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

As used herein, the terms “identifying” and/or “determining” (or any variants thereof such as “identify” and determine”) encompass a wide variety of actions. For example, “identifying” and/or “determining” may include calculating, computing, processing, deriving, investigating, looking up (e.g., looking up in a table, a database or another data structure), ascertaining and the like. Also, “identifying” and/or “determining” may include receiving (e.g., receiving information), accessing (e.g., accessing data in a memory) and the like. Also, “identifying” and/or “determining” may include resolving, selecting, choosing, establishing and the like.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment, comprising: obtaining, from a network entity, a reference signal and a configuration indicating a set of one or more parameters: calculating a path loss based on a predicted channel metric of the reference signal: generate a power headroom report (PHR) based on at least one of the set of one or more parameters, a set of one or more conditions, or the calculated path loss, wherein the PHR indicates at least a power headroom (PH) at a future time instance: outputting the PHR for transmission to the network entity, the output being based on the set of one or more conditions.

Example 2 is the method of example 1, wherein the set of one or more parameters indicate at least one of a threshold timer, a threshold difference in path loss, or a threshold confidence level associated with the predicted channel metric of the reference signal.

Example 3 is the method of example 2, wherein the set of conditions indicate that the PHR is outputted based on a current timer satisfying the threshold timer.

Example 4 is the method of example 2, wherein the set of conditions indicate that the PHR is outputted based on a difference, between the calculated path loss and a path loss associated with a previously outputted PHR, that satisfies the threshold difference in path loss.

Example 5 is the method of example 4, wherein the previously outputted PHR indicates a second PH based on the path loss associated with the previously outputted PHR, and wherein the path loss associated with the previously outputted PHR is based on a measured channel metric of a reference signal associated with the previously outputted PHR.

Example 6 is the method of example 4, wherein the previously outputted PHR indicates a second PH based on the path loss associated with the previously outputted PHR, and wherein the path loss associated with the previously outputted PHR is based on a predicted channel metric of a reference signal associated with the previously outputted PHR.

Example 7 is the method of example 2, wherein set of conditions indicate that the PHR is outputted for transmission based on a confidence level associated with the predicted channel metric satisfying the threshold confidence level.

Example 8 is the method of any of examples 1-7, further comprising: obtaining, from the network entity, a message indicating at least one of a value of the predicted channel metric, a time instance associated with the predicted channel metric, or a confidence level associated with the predicted channel metric.

Example 9 is the method of example 8, wherein the message is a medium access control control element (MAC CE) message or a downlink control information (DCI) message.

Example 10 is the method of example 8, wherein the PHR further indicates at least one of a confidence level associated with the PH, a second time instance at which the message is obtained, or the value of the predicted channel metric.

Example 11 is the method of example 10, wherein the confidence level associated with the PH is based on the confidence level associated with the predicted channel metric.

Example 12 is the method of example 8, further comprising: obtaining, from the network entity, a message indicating an updated uplink transmit power for the time instance associated with the predicted channel metric: and outputting data for transmission to the network entity using the updated uplink transmit power, wherein the data is outputted for transmission at the time instance associated with the predicted channel metric.

Example 13 is the method of any of examples 1-12, wherein the PHR further indicates at least one of a confidence level associated with the PH, a value of the predicted channel metric, a confidence level associated with the predicted channel metric, or a time instance associated with the predicted channel metric.

Example 14 is the method of any of examples 1-13, further comprising: measuring a channel metric of the reference signal, wherein the predicted channel metric of the reference signal is based on at least one of the measured channel metric or an output of a machine learning model: and outputting, for transmission to the network entity, a message indicating the predicted channel metric.

Example 15 is the method of example 14, wherein the predictive PHR further indicates a time instance associated with the message, wherein the time instance associated with the message is before a time instance at which the PHR is outputted.

Example 16 is the method of example 14, wherein the message is a medium access control control element (MAC CE) message or an uplink control information (UCI) message.

Example 17 is the method of example 14, wherein a time instance at which the PHR is outputted is within a threshold time duration starting from a time instance at which the message is outputted.

Example 18 is the method of any of examples 1-17, further comprising: obtaining, from the network entity, at a first time instance, the predicted channel metric, wherein a time instance at which the PHR is outputted is within a threshold time duration of the first time instance.

Example 19 is the method of any of examples 1-18, wherein the calculated path loss is associated with a first time instance, wherein the first time instance occurs after a threshold time duration that is after a time instance at which the PHR is outputted.

Example 20 is the method of any of examples 1-19, wherein the PH is based on a maximum transmit power of the UE at a time instance at which the PHR is outputted for transmission, or wherein the PH is based on a maximum transmit power associated with a first time instance, and the first time instance is associated with the predicted channel metric.

Example 21 is the method of any of examples 1-20, wherein the set of one or more parameters and the set of one or more conditions are associated with a second PHR, and wherein the second PHR indicates a PH that is based on a measured channel metric of the reference signal.

Example 22 is a user equipment (UE) comprising: a transceiver: a memory comprising instructions: and one or more processors configured to cause the UE to perform a method in accordance with any of examples 1-21, wherein the transceiver is configured to: receive the reference signal and the configuration: and transmit the PHR.

Example 23 is a method of a wireless communication at a network entity, comprising: outputting, for transmission to a User Equipment (UE), a reference signal and a configuration indicating a set of one or more parameters: and obtaining, from the UE, a power headroom report (PHR), wherein the PHR is based on at least one of the set of one or more parameters, a set of one or more conditions, or a path loss, and wherein the PHR indicates at least a power headroom (PH) at a future time instance, and wherein the path loss is based on a predicted channel metric.

Example 24 is the method of example 23, wherein the set of one or more parameters indicate at least one of a threshold timer, a threshold difference in path loss, or a threshold confidence level associated with the predicted channel metric of the reference signal.

Example 25 is the method of example 24, wherein the set of conditions indicate at least one of a timer of the UE satisfying the threshold timer, a difference between the path loss and a path loss associated with a previously obtained PHR satisfying a threshold difference in path loss, or a confidence level associated with the predicted channel metric satisfying the threshold confidence level.

Example 26 is the method of any of examples 23-25, further comprising: outputting, for transmission to the UE, a message indicating at least one of a value of the predicted channel metric, a time instance associated with the predicted channel metric, or a confidence level associated with the predicted channel metric.

Example 27 is the method of example 26, further comprising: measuring a channel metric of the reference signal, wherein the predicted channel metric of the reference signal is based on at least one of the measured channel metric or an output of a machine learning model.

Example 28 is the method of example 26, wherein the message is a medium access control control element (MAC CE) message or a downlink control information (DCI) message.

Example 29 is the method of example 26, wherein the PHR further indicates at least one of a confidence level associated with the PH, a second time instance at which the message is outputted, or the value of the predicted channel metric, and wherein the confidence level associated with the PH is based on the confidence level associated with the predicted channel metric.

Example 30 is the method of example 29, further comprising: determining that the PH indicated in the PHR is associated with the time instance associated with the predicted channel metric, the determination being based on the second time instance indicated in the PHR: and outputting, for transmission to the UE, a second message configured to update an uplink transmit power of the UE for the time instance associated with the predicted channel metric, wherein the updated uplink transmit power is based on the PH indicated in the PHR.

Example 31 is the method of any of examples 23-30, further comprising: obtaining, from the UE, a message indicating the predicted channel metric or a confidence level associated with the predicted channel metric.

Example 32 is the method of example 31, wherein the predictive PHR further indicates a time instance associated with the message, wherein the time instance associated with the message is before a time instance at which the PHR is obtained.

Example 33 is the method of example 31, wherein the message is a medium access control control element (MAC CE) message or an uplink control information (UCI) message.

Example 34 is the method of any of examples 23-33, further comprising: outputting, for transmission to the UE, at a first time instance, the predicted channel metric, wherein a time instance at which the PHR is obtained is within a threshold time duration starting from the first time instance.

Example 35 is the method of any of examples 23-34, wherein the path loss is associated with a first time instance, wherein the first time instance occurs after a threshold time duration that is after a time instance at which the PHR is obtained.

Example 36 is the method of any of examples 23-35, wherein the PH is based on a maximum transmit power of the apparatus at a time instance at which the PHR is obtained.

Example 37 is the method of any of examples 23-36, wherein the PH is based on a maximum output power of the UE, wherein the maximum output power is associated with a first time instance, and the first time instance is associated with the predicted channel metric.

Example 38 is the method of any of examples 23-37, wherein the set of one or more parameters and the set of one or more conditions are associated with a second PHR, and wherein the second PHR indicates a PH that is based on a measured channel metric of the reference signal.

Example 39 is a network entity comprising: a transceiver: a memory comprising instructions: and one or more processors configured to cause the network entity to perform a method in accordance with any of examples 23-38, wherein the transceiver is configured to: transmit the reference signal and the configuration; and receive the PHR.

Example 40 is an apparatus for wireless communications, comprising means for performing a method in accordance with any of examples 1-21.

Example 41 is a non-transitory computer readable medium comprising instructions that, when executed by an apparatus, causes the apparatus to perform a method in accordance with any of examples 1-21.

Example 42 is an apparatus for wireless communications, comprising: a memory comprising instructions; and one or more processors configured to execute the instructions to cause the apparatus to perform a method in accordance with any one of examples 1-21.

Example 43 is an apparatus for wireless communications, comprising means for performing a method in accordance with any of examples 23-38.

Example 44 is a non-transitory computer readable medium comprising instructions that, when executed by an apparatus, causes the apparatus to perform a method in accordance with any of examples 23-38.

Example 45 is apparatus for wireless communications, comprising: a memory comprising instructions; and one or more processors configured to execute the instructions to cause the apparatus to perform a method in accordance with any one of examples 23-38.

1. An apparatus configured for wireless communication, comprising:
a memory comprising instructions; and
one or more processors configured to execute the instructions and cause the apparatus to:
obtain, from a network entity, a reference signal and a configuration indicating a set of one or more parameters;
calculate a path loss based on a predicted channel metric of the reference signal;
generate a power headroom report (PHR) based on at least one of the set of one or more parameters, a set of one or more conditions, or the calculated path loss, wherein the PHR indicates at least a power headroom (PH) at a future time instance; and
output the PHR for transmission to the network entity, the output being based on the set of one or more conditions.

2. The apparatus of claim 1, wherein the set of one or more parameters indicate at least one of a threshold timer, a threshold difference in path loss, or a threshold confidence level associated with the predicted channel metric of the reference signal.

3. The apparatus of claim 2, wherein at least one of:
the set of conditions indicate that the PHR is outputted based on a current timer satisfying the threshold timer;
the set of conditions indicate that the PHR is outputted based on a difference, between the calculated path loss and a path loss associated with a previously outputted PHR, that satisfies the threshold difference in path loss; or
the set of conditions indicate that the PHR is outputted for transmission based on a confidence level associated with the predicted channel metric satisfying the threshold confidence level.

4. (canceled)

5. The apparatus of claim 4, wherein at least one of:
the previously outputted PHR indicates a second PH based on the path loss associated with the previously outputted PHR, and wherein the path loss associated with the previously outputted PHR is based on a measured channel metric of a reference signal associated with the previously outputted PHR; or
the previously outputted PHR indicates a second PH based on the path loss associated with the previously outputted PHR, and wherein the path loss associated with the previously outputted PHR is based on a predicted channel metric of a reference signal associated with the previously outputted PHR.

6. (canceled)

7. The apparatus of claim 2, wherein the set of conditions indicate that the PHR is outputted for transmission based on a confidence level associated with the predicted channel metric satisfying the threshold confidence level.

8. The apparatus of claim 1, wherein the one or more processors are further configured to cause the apparatus to:
obtain, from the network entity, a message indicating at least one of a value of the predicted channel metric, a time instance associated with the predicted channel metric, or a confidence level associated with the predicted channel metric.

9. The apparatus of claim 8, wherein at least one of:
the PHR further indicates at least one of a confidence level associated with the PH, a second time instance at which the message is obtained, or the value of the predicted channel metric; or
the confidence level associated with the PH is based on the confidence level associated with the predicted channel metric.

10. (canceled)

11. The apparatus of claim 8, wherein the one or more processors are further configured to cause the apparatus to:
obtain, from the network entity, a second message indicating an updated uplink transmit power for the time instance associated with the predicted channel metric; and
output data for transmission to the network entity using the updated uplink transmit power, wherein the data is outputted for transmission at the time instance associated with the predicted channel metric.

12. The apparatus of claim 1, wherein at least one of:
the PHR further indicates at least one of a confidence level associated with the PH, a value of the predicted channel metric, a confidence level associated with the predicted channel metric, or a time instance associated with the predicted channel metric;
the calculated path loss is associated with a first time instance, wherein the first time instance occurs after a threshold time duration that is after a time instance at which the PHR is outputted;
the PH is based on a maximum transmit power of the apparatus at a time instance at which the PHR is outputted for transmission;
the PH is based on a maximum transmit power associated with a first time instance, and the first time instance is associated with the predicted channel metric; or
the set of one or more parameters and the set of one or more conditions are associated with a second PHR, and the second PHR indicates a PH that is based on a measured channel metric of the reference signal.

13. The apparatus of claim 1, wherein the one or more processors are further configured to cause the apparatus to:
measure a channel metric of the reference signal, wherein the predicted channel metric of the reference signal is based on at least one of the measured channel metric or an output of a machine learning model; and
output, for transmission to the network entity, a message indicating the predicted channel metric.

14. The apparatus of claim 13, wherein at least one of:
the PHR further indicates a time instance associated with the message, wherein the time instance associated with the message is before a time instance at which the PHR is outputted; or
a time instance at which the PHR is outputted is within a threshold time duration starting from a time instance at which the message is outputted.

15. (canceled)

16. The apparatus of claim 1, wherein the one or more processors are further configured to cause the apparatus to:
obtain, from the network entity, at a first time instance, the predicted channel metric, wherein a time instance at which the PHR is outputted is within a threshold time duration starting from the first time instance.

17-20. (canceled)

21. An apparatus configured for wireless communication, comprising:
a memory comprising instructions; and
one or more processors configured to execute the instructions and cause the apparatus to:
output, for transmission to a User Equipment (UE), a reference signal and a configuration indicating a set of one or more parameters; and
obtain, from the UE, a power headroom report (PHR), wherein the PHR is based on at least one of the set of one or more parameters, a set of one or more conditions, or a path loss, and
wherein the PHR indicates at least a power headroom (PH) at a future time instance, and wherein the path loss is based on a predicted channel metric.

22. The apparatus of claim 21, wherein at least one of:
the set of one or more parameters indicate at least one of a threshold timer, a threshold difference in path loss, or a threshold confidence level associated with the predicted channel metric of the reference signal; or
the set of one or more parameters and the set of one or more conditions are associated with a second PHR, and wherein the second PHR indicates a PH that is based on a measured channel metric of the reference signal.

23. The apparatus of claim 22, wherein the set of conditions indicate at least one of a timer of the UE satisfying the threshold timer, a difference between the path loss and a path loss associated with a previously obtained PHR satisfying a threshold difference in path loss, or a confidence level associated with the predicted channel metric satisfying the threshold confidence level.

24. The apparatus of claim 21, wherein the one or more processors are further configured to cause the apparatus to:
output, for transmission to the UE, a message indicating at least one of a value of the predicted channel metric, a time instance associated with the predicted channel metric, or a confidence level associated with the predicted channel metric.

25. The apparatus of claim 24, wherein the one or more processors are further configured to cause the apparatus to:
measure a channel metric of the reference signal, wherein the predicted channel metric of the reference signal is based on at least one of the measured channel metric or an output of a machine learning model.

26. The apparatus of claim 24, wherein the PHR further indicates at least one of a confidence level associated with the PH, a second time instance at which the message is outputted, or the value of the predicted channel metric, and wherein the confidence level associated with the PH is based on the confidence level associated with the predicted channel metric.

27. The apparatus of claim 26, wherein the one or more processors are further configured to cause the apparatus to:
determine that the PH indicated in the PHR is associated with the time instance associated with the predicted channel metric, the determination being based on the second time instance indicated in the PHR; and
output, for transmission to the UE, a second message configured to update an uplink transmit power of the UE for the time instance associated with the predicted channel metric, wherein the updated uplink transmit power is based on the PH indicated in the PHR.

28. The apparatus of claim 21, wherein the one or more processors are further configured to cause the apparatus to:
output, for transmission to the UE, at a first time instance, the predicted channel metric, wherein a time instance at which the PHR is obtained is within a threshold time duration starting from the first time instance.

29-30. (canceled)
